(19) United States
(12) Patent Application Publication
(10) Pub. No.: US 2021/0406693 A1
(43) Pub. Date: Dec. 30, 2021

(54) DATA SAMPLE ANALYSIS IN A DATASET FOR A MACHINE LEARNING MODEL

(71) Applicant: NXP B.V., Eindhoven (NL)

(72) Inventors: Christine VAN VREDENDAAL, Veldhoven (NL); Wilhelmus Petrus Adrianus Johannus Michiels, Reusel (NL); Gerardus Antonius Franciscus Derks, Dongen (NL); Brian Ermans, 's-Hertogenbosch (NL)

(21) Appl. No.: 16/912,052

(22) Filed: Jun. 25, 2020

(51) Int. Cl. G06N 3/08; G06N 20/00; G06K 9/62

(52) U.S. Cl. CPC G06N 3/084; G06K 9/623; G06K 9/6215; G06N 20/00

(57) ABSTRACT

A method is described for analyzing data samples of a machine learning (ML) model to determine why the ML model classified a sample like it did. Two samples are chosen for analysis. The two samples may be nearest neighbors. Samples classified as nearest neighbors are typically samples that are more similar with respect to a predetermined criterion than other samples of a set of samples. In the method, a first set of features of a first sample and a second set of features of a second sample are collected. A set of overlapping features of the first and second sets of features is determined. Then, the set of overlapping features is analyzed using a predetermined visualization technique to determine why the ML model determined the first sample to be similar to the second sample.

### BACKGROUND

### Field

This disclosure relates generally to machine learning (ML), and more particularly, to data sample analysis in a dataset for a ML model.

### Related Art

Machine learning is becoming more widely used in many of today's applications, such as applications involving forecasting and classification. Generally, a machine learning (ML) model is trained, at least partly, before it is used. Training data is used for training a ML model. Machine learning models may be classified by how they are trained. Supervised learning, unsupervised learning, semi-supervised learning, and reinforcement learning are examples of training techniques. The effectiveness of a ML algorithm, which includes the model's, accuracy, execution time, and storage requirements, is determined by several factors including the quality of the training data.

Trained ML models are often considered “black-boxes” by users because there may be very little information available on inner workings of the model. For example, it might not be clear why certain samples are flagged as similar from a visual inspection. It would be useful to have information to help determine why an ML model makes certain predictions so that either the model and/or the training data can be improved.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates a system for training a ML model.

FIG. 2 illustrates a neural network in accordance with an embodiment.

FIG. 3 illustrates a method for analyzing data samples in a machine learning model.

FIG. 4 illustrates a data processing system suitable for implementing the method of FIG. 3.

### DETAILED DESCRIPTION

Generally, there is provided, in one embodiment, a method for analyzing similarities between two data samples S and T of a machine learning dataset. In one embodiment, sample S is the input sample being classified by a ML model, and sample T may be a nearest neighbor to sample S. That is, sample T may be a sample that has been classified similarly to sample S by the ML model. The ML model may include a neural network. Each of samples S and T are made up of features. The features of a sample are what the ML model uses to determine an output classification for the sample. The features of samples S and T are represented by values derived from results of an intermediate layer of the neural network, for example, the last convolutional layer. In one embodiment, a value may be an intermediate result multiplied by a gradient of a node of the intermediate layer.

In the method, a set I of shared, or overlapping, features of the two samples S and T is created. In one embodiment, the set I of shared features is created by collecting the features that have non-zero values for each of the two samples S and T to produce a set of features for sample S and a set of features for sample T. For each feature of the set I of shared feature and represents a rank or score of the feature relative to other features. The value reflects how important the feature is in a prediction involving the two samples. In one embodiment, a lower value represents a higher rank. The rank of a feature in set I of shared features is a sum of the scores in samples S and T for the feature. The scores can be rank-ordered and the set I can be a predetermined number of the lowest (best) scores. In another embodiment, a higher score can be represented using a higher value, so that the scores can be rank-ordered with the highest (best) scores at the top of the list.

After creating the set I, one or more visualization methods can be used to analyze the set I. In one approach, a neural network of the ML model is inverted to find an input that maximizes an activation of the considered feature set. For example, the nodes of the neural network may be inverted starting from the predetermined layer back to the input layer of the network. In another approach, areas in the samples S and T are located that cause the activation of set I. This can be done using, e.g., heatmaps, where gradients of the input pixels for either or both of feature sets of samples S or T are computed. The gradients are translated into colors and overlaid to see the overlapping features. Instead of the heatmaps, a feature map can be used that relates the output of the convolutional layers. The areas in the feature maps straightforwardly relate to areas in the input samples. Using the related areas, the areas in the samples S and T can be highlighted that are most important for the result obtained by the ML model.

The analysis method aids in the understanding of operations of a ML model and the structure of a training dataset by determining the features of samples that the ML model uses to classify two samples as similar. Presenting these overlapping features aids in the understanding of why the ML model misclassifies a sample, as well as the dataset used to train the ML model.

In accordance with an embodiment, there is provided, a method for analyzing data samples of a machine learning model, the method including: determining a first set of features of a first sample and a second set of features of a second sample; determining a set of overlapping features of the first and second sets of features; and presenting the set of overlapping features using a predetermined visualization technique to analyze features the machine learning model used to determine the first sample is similar to the second sample. The first sample may be an input sample to the machine learning model for classification and the second sample may be a nearest neighbor to the first sample. The machine learning model may be based on a neural network having a plurality of layers, and wherein the first and second sets of features are non-zero outputs from nodes of a predetermined layer of the plurality of layers. A ranking of a feature may be a function of an output of a node multiplied by a gradient of the node. The predetermined layer may be a last convolutional layer of the neural network. Determining a set of overlapping features of the first and second sets of features may further include: rank-ordering the non-zero outputs from nodes of the predetermined layer; and selecting a predetermined number of highest ranked features. Presenting the set of overlapping features using a predetermined visualization technique may further include inverting the outputs of the nodes of the predetermined layer to maximize activation of the overlapping features. Determining a set of overlapping features of the first and second sets of features may further include determining a Euclidean distance between nodes of an intermediate layer as a function of the non-zero outputs of the nodes of the intermediate layer and gradients of the nodes of the intermediate layer. Presenting the set of overlapping features using a predetermined visualization technique may further include using a heat map or a feature map to correlate a predetermined number of features of the set of overlapping features. Presenting the set of overlapping features using a predetermined visualization technique may further include determining areas of the first and second samples that cause the activation of the overlapping features using one of a heat map or a feature map.

In another embodiment, there is provided, a method for analyzing data samples of a machine learning model based on a neural network having a plurality of layers, the method including: determining a first set of features of a first sample and a second set of features of a second sample, wherein the first and second sets of features are a function of non-zero outputs from nodes of a predetermined layer of the plurality of layers; determining a set of overlapping features of the first and second sets of features; and presenting the set of overlapping features using a predetermined visualization technique to analyze features the machine learning model used to determine the first sample is similar to the second sample. A ranking of a feature may be a function of the non-zero output of a node multiplied by a gradient of the node. The predetermined layer may be a last convolutional layer of the neural network. Determining a set of overlapping features of the first and second sets of features may further include: rank-ordering the non-zero outputs from nodes of the predetermined layer; and selecting a predetermined number of highest ranked features. Presenting the set of overlapping features using a predetermined visualization technique may further include inverting the non-zero outputs of the nodes of the predetermined layer to maximize activation of the overlapping features. Determining a set of overlapping features of the first and second sets of features may further include determining a Euclidean distance between nodes of the predetermined layer of the neural network as a function of non-zero outputs of nodes of the predetermined layer and gradients of the nodes of the predetermined layer.

In yet another embodiment, there is provided, a method for analyzing data samples of a machine learning model based on a neural network having a plurality of layers, the method including: determining a first set of features of a first sample and a second set of features of a second sample, wherein the first and second sets of features are based on gradients of nodes of a last convolutional layer of the plurality of layers; determining a set of overlapping features of the first and second sets of features by rank-ordering outputs of the nodes of the last convolutional layer and selecting a predetermined number of highest ranked overlapping features; and presenting the set of overlapping features using a predetermined visualization technique to analyze features the machine learning model used to determine the first sample is similar to the second sample. Presenting the set of overlapping features using a predetermined visualization technique may further include inverting the outputs of the nodes of the last convolutional layer to maximize activation of the overlapping features. Determining a set of overlapping features of the first and second sets of features may further include determining a Euclidean distance between nodes of the last convolutional layer as a function of non-zero outputs of the nodes of the last convolutional layer and gradients of the nodes of the last convolutional layer. Presenting the set of overlapping features using a predetermined visualization technique may further include determining areas of the first and second samples that cause the activation of the overlapping features using one of a heat map or a feature map.

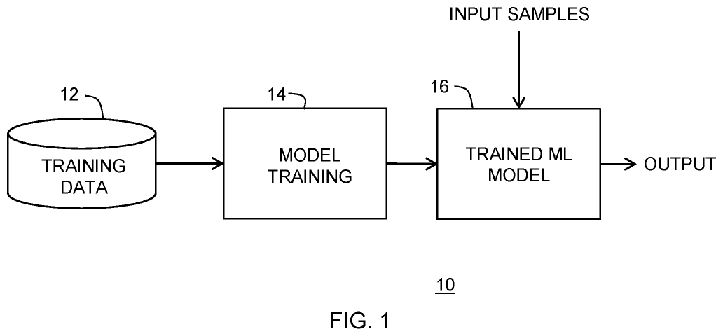

FIG. 1 illustrates system 10 for training a ML model. System 10 includes a labeled set of ML training data 12, model training block 14, and resulting trained ML model 16. In one embodiment, system 10 is implemented as a computer program stored on a non-transitory medium comprising executable instructions.

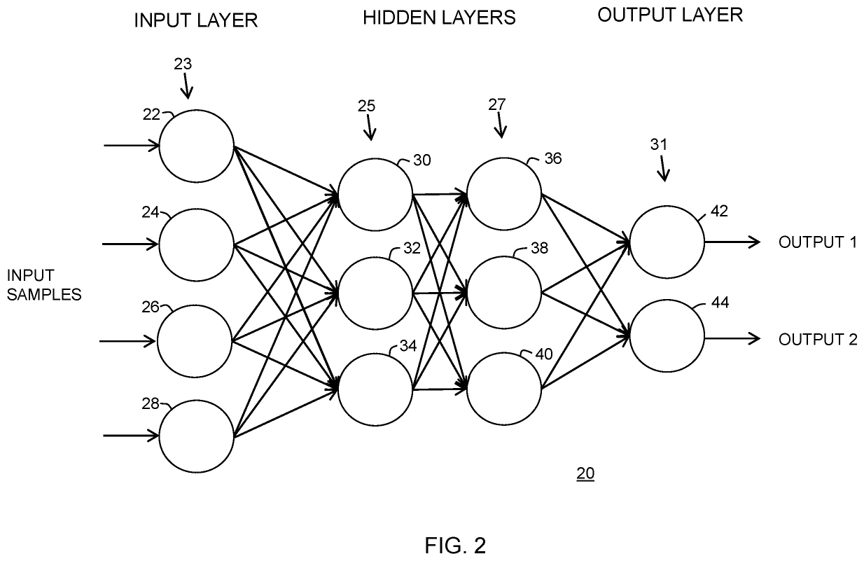

One example embodiment includes a neural network (NN) algorithm used in the ML model to classify images. An example of a neural network is illustrated in FIG. 2. Various training datasets can be acquired to train an ML model, such as for example, the CIFAR10 data set. The CIFAR10 data set consists of 60K images, divided into a training set of 50K images (5K per class) and a test set of 10K images (1K per class).

Training the ML model during model training 14 with training dataset 12 results in trained ML model 16. Trained ML model 16 may then be used to classify input samples during inference operation. During inference operation input samples labeled “INPUT SAMPLES” in FIG. 1 are input to trained ML model 16 and trained ML model 16 outputs a classification of the input sample labeled “OUTPUT.”

Even though a ML model might be carefully trained, the ML model may still make prediction mistakes. Sometimes it is not clear why the ML model classifies some input samples incorrectly. The method as described herein provides further understanding of the mechanisms behind prediction results provided by ML models. Specifically, the method can help a ML model designer understand why a model made a prediction, either a correct prediction or an incorrect prediction. The information learned from the method can be used to compile better training data and to design better and safer systems with ML models.

FIG. 2 illustrates neural network 20 in accordance with an embodiment. Generally, with neural networks, there are many possible configurations of nodes and connections between the nodes. Neural Network 20 is only one simple embodiment for illustrating and describing an embodiment of the invention. Other embodiments can have a different configuration with a different number of layers and nodes. Each layer can have any number of nodes, or neurons. Neural network 20 includes input layer 23, hidden layers 25 and 27, and output layer 31. Input layer 23 includes nodes 22, 24, 26, and 28, hidden layer 25 includes nodes 30, 32, and 34, hidden layer 27 includes nodes 36, 38, and 40, and output layer 31 includes nodes 42 and 44. Hidden layer 27 is considered a final convolutional layer of neural network 20. Each of the nodes in output layer 31 corresponds to a prediction category and provides an output classification OUTPUT 1 and OUTPUT 2. In other embodiments, there can be a different number of layers and each layer may have a different number of nodes. All the nodes in the layers are interconnected with each other. There are many variations for interconnecting the nodes. The layers illustrated in the example of FIG. 2 may be considered fully-connected because a node in one layer is connected with all the nodes of the next layer. In the drawings, arrows indicate connections between the nodes. The connections are weighted by training and each node includes an activation function.

During training, input samples labeled “INPUT SAMPLES” are provided to input layer 23. Each of the nodes are weighted and includes an activation function. Also, the activation functions may include non-linear activation functions. A strength of the weights of the various connections is adjusted during training based on the input samples from a training data set. The input sample is provided at the input layer and propagates through the network to the output layers. The propagation through the network includes the calculation of values for the layers of the neural network, including intermediate values for the hidden intermediate layers. Back propagation in the reverse direction through the layers is also possible and may be used to generate the gradients described herein below. Weights and biases are applied at each of the nodes of the neural network. The outputs of the intermediate hidden layers can be changed by changing their weights and biases. Generally, a weight at a node determines the steepness of the activation function and the bias at a node delays a triggering of the activation function. In one embodiment, a calculated gradient at a node is related to the weights and bias. One or more output signals are computed based on a weighted sum of the inputs and outputs from the output nodes. The activation functions, the weights, the biases, and the input to a node defines the output.

The analysis of the overlapping features of two samples begins with determining which samples to analyze. In one embodiment, the k nearest neighbors to the input sample of interest are calculated, where k is the number of nearest neighbors to be calculated. One way to determine the k nearest neighbors may be done by taking gradients calculated from the training dataset and finding the k nearest neighbors. In another embodiment, the gradients of nodes in one layer are combined with the intermediate output values of the same layer. The k nearest neighbors can be determined using various known algorithms such as kNN, R-tree, or Kd-tree. The k nearest neighbors can be presented for analysis in various ways as determined by the specific application. The use of a filter may be enhanced with a known interpretability method such as Grad-CAM (gradient class-activation map) or guided Grad-CAM.

In another embodiment, a distance metric for deciding which samples are the k nearest neighbors can be calculated by measuring the Lp-Norm (e.g., Manhattan or Euclidean) by counting the number of shared non-zero values (Hamming distance), or any other method not mentioned. The distance metric can be used as another filter because finding the distance to other samples is how the k nearest neighbors are determined. For example, samples with a large distance to their neighbors are expected to be very atypical because the large distance indicates the samples have very few features in common. However, these atypical samples may be of interest for understanding why the samples under analysis were misclassified.

In a convolutional neural network filters may be applied to a sample. These filters “extract” the important features of the sample and represent the important features as feature vectors that are used as input to the fully-connected layers of the neural network. The fully connected layers then compute the output of the network. The outputs of a layer are fed to the inputs of a subsequent layer. Backpropagation may be used to calculate the magnitude of the change in the output layer of a network as a function of change in an intermediate layer. The magnitude of the change is a derivative function that describes the gradient and may be used to determine the nearest neighbors. In one embodiment of the present invention, the gradient is also used to determine the ranking of the features in overlapping feature set I. For example, the ranking of a feature may be a function of the output of a node multiplied by a gradient of the node The gradients of the last hidden convolutional layer of the neural network may be used for the ranking. In another embodiment, node outputs of a different layer may be used. Also, a different indicator other than the multiplication of a node output with the node gradient can be used to rank the overlapping features.

In addition to, or instead of, using the gradient of the node outputs to determine which samples to analyze, the selection of the samples to be compared can be based on different criteria. For instance, does a sample belong to a class that is often misclassified?

The method for analyzing overlapping features may provide insight about a dataset by combining interpretability techniques with the above described k nearest neighbor techniques. By visualizing the most important features that are causing the nearest neighbors to be in fact nearest neighbors, more insight may be provided into the training data, test data, and network behavior.

Described differently, a set I of overlapping features is constructed of the most important features shared between the samples S and T, where S is an input sample requiring classification, and sample T is one of the k nearest neighbors determined using one of the above described techniques for determining the k nearest neighbors. Sample S={s1, . . . ,sn} and sample T={t1, . . . ,tn}. The values si and ti represent gradient-based feature values that may also be used for determining the nearest neighbors, and n represents the number of nodes in a layer of a neural network. In one embodiment, the features of a sample are a function of the node output and another parameter such as the gradient of the node. To create set I, features of both samples are selected for which the gradient-based output values from nodes of a neural network intermediate layer for samples S and T are non-zero. That is, a feature i is considered if and only if si≠0 and ti≠0. For samples S and T, the gradient-based features in set I may be ordered from large to small. A feature rank is the sum of the rank the feature has in the ordering for samples S and T. The most important overlapping features are the highest (best) ranked features. A predetermined number of the best overlapping features (highest value) can then be analyzed. Also, in another embodiment, the best score may be the lowest value. In this case, the best possible value, or highest rank, may be when two features both have a value of one, which sums to a rank value of two.

Alternatively, given n-dimensional feature vectors as neural network node outputs, the overlapping feature set I can be determined using k<n-dimensional sub-vector of features such that the Euclidean distance (or any other norm) between S′={si|i in I} and T′={ti|i in I} is minimized. In one embodiment, the Euclidean distance between nodes of a layer may be a function of the non-zero outputs of the nodes of the layer and gradients of the nodes of the layer. Also, in another embodiment, the sub-vector of features i in set I, such that the magnitude of si −ti is below a predetermined threshold, determines the selected features. In addition, the important features can be manually selected given the user already has some insight into the data. Also, a user may differentiate between the positively contributing features (those that contribute positively to the classification class of a sample), and the negatively contributing features (those that reduce the confidence in the classification of the sample) to determine the best overlapping features.

After a set I of overlapping features is determined, a visualization of the features is presented to the user. Various interpretability techniques can be used to visualize the overlapping features of samples S and T from set I. For example, in one approach, the neural network can be inverted to find an input that maximizes the activation of the considered overlapping feature set. Then, areas in the samples S and T are found that cause the activation of the considered feature set using a heat map or feature map. A possible approach for a feature map is to use the GradCAM interpretability technique. Using the overlapping features can make clearer why two samples are similar with respect to a chosen metric, such as, e.g., the gradient of the nodes of a predetermined layer of a neural network.

Also, additional functionality can be provided based on the visualization technique being used. For example, the dataset may be augmented by removing a feature from a sample that causes an input sample to be wrongly classified. In one example of a system for classifying images, if a rope on a misclassified picture is shown to be an overlapping feature for classifying, for example, an image of a house as an image of a dog, then a user may blacken out the rope and thus augment the dataset. Also, in another example of additional functionality, a notification may be provided to the user in response to selected overlaps in the features. For example, a notification might be: “The overlapping features cover the entire sample, might this be an unclear sample?”

Depending on the implementation of the invention, the information gained from the invention might be used to improve a ML training dataset and thereby improve the quality of a resulting trained model. Alternatively, notifications may be provided to improve usability of a trained ML model. Also, the method may be automated. Also, described added functionality may be automatically applied. The described method improves performance of a neural network and/or a training dataset for a ML model.

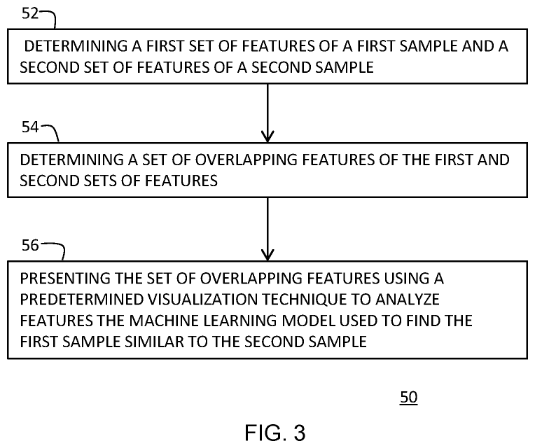

FIG. 3 illustrates method 50 for analyzing data samples in a ML model. The ML model may include a neural network. Method 50 starts at step 52. At step 52, a first set of features is collected for a first sample S and a second set of features is collected for a second sample T. The first sample S may be an input sample to a ML model for classification. The second sample T may be a nearest neighbor to the first sample. The collected features are non-zero features from an intermediate layer of, e.g., a neural network. The intermediate layer may be a last convolutional layer in one embodiment. At step 54, a set I of overlapping features of the first and second sets of features is determined. In one embodiment, ranks of the overlapping features are determined and are a function of the gradients of the nodes of the intermediate layer and the outputs from the nodes. A predetermined number of the highest ranked features are selected. At step 56, the predetermined number of rank-ordered overlapping features are presented using a visualization technique. The visualization technique may include using a heat map or feature map that shows the important overlapping features. The presented features of set I can then be analyzed to determined what features the ML model used to classify sample S and sample T as similar.

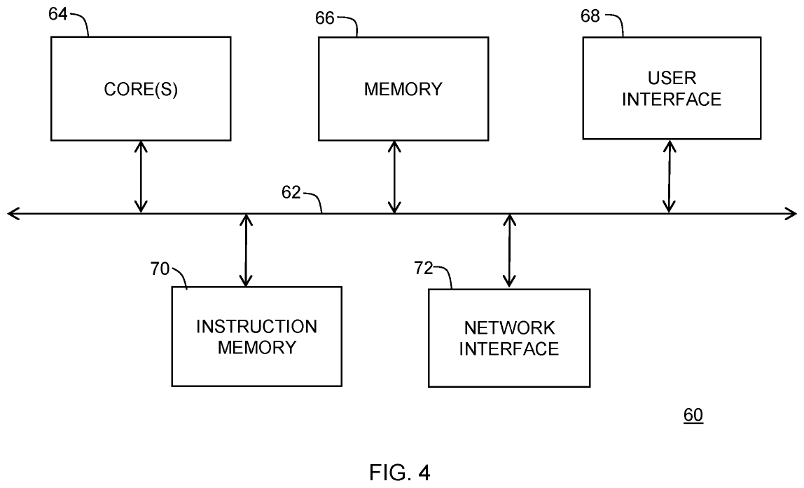

FIG. 4 illustrates a data processing system 60 suitable for implementing the method of FIG. 3. Data processing system 60 may be implemented on one or more integrated circuits and may be used in an implementation of the described embodiments. Data processing system 60 includes bus 62. Connected to bus 62 is one or more processor cores 64, memory 66, user interface 68, instruction memory 70, and network interface 72. The one or more processor cores 64 may include any hardware device capable of executing instructions stored in memory 66 or instruction memory 70. For example, processor cores 64 may execute the machine learning algorithms used for training and operating the ML model. Processor cores 64 may be, for example, a microprocessor, field programmable gate array (FPGA), application-specific integrated circuit (ASIC), or similar device. Processor cores 64 may be implemented in a secure hardware element and may be tamper resistant.

Memory 66 may be any kind of memory, such as for example, L1, L2, or L3 cache or system memory. Memory 66 may include volatile memory such as static random-access memory (SRAM) or dynamic RAM (DRAM), or may include non-volatile memory such as flash memory, read only memory (ROM), or other volatile or non-volatile memory. Also, memory 66 may be implemented in a secure hardware element. Alternately, memory 66 may be a hard drive implemented externally to data processing system 60. In one embodiment, memory 66 is used to store weight matrices for the ML model.

User interface 68 may be connected to one or more devices for enabling communication with a user such as an administrator. For example, user interface 68 may be enabled for coupling to a display, a mouse, a keyboard, or other input/output device. Network interface 72 may include one or more devices for enabling communication with other hardware devices. For example, network interface 72 may include, or be coupled to, a network interface card (NIC) configured to communicate according to the Ethernet protocol. Also, network interface 72 may implement a TCP/IP stack for communication according to the TCP/IP protocols. Data samples for classification may be input via network interface 72, or similar interface. Various other hardware or configurations for communicating are available.

Instruction memory 70 may include one or more machine-readable storage media for storing instructions for execution by processor cores 64. In other embodiments, both memories 66 and 70 may store data upon which processor cores 64 may operate. Memories 66 and 70 may also store, for example, encryption, decryption, and verification applications. Memories 66 and 70 may be implemented in a secure hardware element and may be tamper resistant.

Various embodiments, or portions of the embodiments, may be implemented in hardware or as instructions on a non-transitory machine-readable storage medium including any mechanism for storing information in a form readable by a machine, such as a personal computer, laptop computer, file server, smart phone, or other computing device. The non-transitory machine-readable storage medium may include volatile and non-volatile memories such as read only memory (ROM), random access memory (RAM), magnetic disk storage media, optical storage medium, flash memory, and the like. The non-transitory machine-readable storage medium excludes transitory signals.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for analyzing data samples of a machine learning model, the method comprising:
determining a first set of features of a first sample and a second set of features of a second sample;
determining a set of overlapping features of the first and second sets of features; and
presenting the set of overlapping features using a predetermined visualization technique to analyze features the machine learning model used to determine the first sample is similar to the second sample.

2. The method of claim 1, wherein the first sample is an input sample to the machine learning model for classification and the second sample is a nearest neighbor to the first sample.

3. The method of claim 1, wherein the machine learning model is based on a neural network having a plurality of layers, and wherein the first and second sets of features are non-zero outputs from nodes of a predetermined layer of the plurality of layers.

4. The method of claim 3, wherein a ranking of a feature is a function of an output of a node multiplied by a gradient of the node.

5. The method of claim 3, wherein the predetermined layer is a last convolutional layer of the neural network.

6. The method of claim 3, wherein determining a set of overlapping features of the first and second sets of features further comprises:
rank-ordering the non-zero outputs from nodes of the predetermined layer; and
selecting a predetermined number of highest ranked features.

7. The method of claim 3, wherein presenting the set of overlapping features using a predetermined visualization technique further comprises inverting the outputs of the nodes of the predetermined layer to maximize activation of the overlapping features.

8. The method of claim 3, wherein determining a set of overlapping features of the first and second sets of features further comprises determining a Euclidean distance between nodes of an intermediate layer as a function of the non-zero outputs of the nodes of the intermediate layer and gradients of the nodes of the intermediate layer.

9. The method of claim 1, wherein presenting the set of overlapping features using a predetermined visualization technique further comprises using a heat map or a feature map to correlate a predetermined number of features of the set of overlapping features.

10. The method of claim 1, wherein presenting the set of overlapping features using a predetermined visualization technique further comprises determining areas of the first and second samples that cause the activation of the overlapping features using one of a heat map or a feature map.

11. A method for analyzing data samples of a machine learning model based on a neural network having a plurality of layers, the method comprising:
determining a first set of features of a first sample and a second set of features of a second sample, wherein the first and second sets of features are a function of non-zero outputs from nodes of a predetermined layer of the plurality of layers;
determining a set of overlapping features of the first and second sets of features; and
presenting the set of overlapping features using a predetermined visualization technique to analyze features the machine learning model used to determine the first sample is similar to the second sample.

12. The method of claim 11, wherein a ranking of a feature is a function of the non-zero output of a node multiplied by a gradient of the node.

13. The method of claim 11, wherein the predetermined layer is a last convolutional layer of the neural network.

14. The method of claim 11, wherein determining a set of overlapping features of the first and second sets of features further comprises:
rank-ordering the non-zero outputs from nodes of the predetermined layer; and
selecting a predetermined number of highest ranked features.

15. The method of claim 11, wherein presenting the set of overlapping features using a predetermined visualization technique further comprises inverting the non-zero outputs of the nodes of the predetermined layer to maximize activation of the overlapping features.

16. The method of claim 11, wherein determining a set of overlapping features of the first and second sets of features further comprises determining a Euclidean distance between nodes of the predetermined layer of the neural network as a function of non-zero outputs of nodes of the predetermined layer and gradients of the nodes of the predetermined layer.

17. A method for analyzing data samples of a machine learning model based on a neural network having a plurality of layers, the method comprising:
determining a first set of features of a first sample and a second set of features of a second sample, wherein the first and second sets of features are based on gradients of nodes of a last convolutional layer of the plurality of layers;
determining a set of overlapping features of the first and second sets of features by rank-ordering outputs of the nodes of the last convolutional layer and selecting a predetermined number of highest ranked overlapping features; and
presenting the set of overlapping features using a predetermined visualization technique to analyze features the machine learning model used to determine the first sample is similar to the second sample.

18. The method of claim 17, wherein presenting the set of overlapping features using a predetermined visualization technique further comprises inverting the outputs of the nodes of the last convolutional layer to maximize activation of the overlapping features.

19. The method of claim 17, wherein determining a set of overlapping features of the first and second sets of features further comprises determining a Euclidean distance between nodes of the last convolutional layer as a function of non-zero outputs of the nodes of the last convolutional layer and gradients of the nodes of the last convolutional layer.

20. The method of claim 17, wherein presenting the set of overlapping features using a predetermined visualization technique further comprises determining areas of the first and second samples that cause the activation of the overlapping features using one of a heat map or a feature map.
